(19) United States
(12) Patent Application Publication
(10) Pub. No.: US 2021/0316173 A1
(43) Pub. Date: Oct. 14, 2021

(54) Face Mask With Replaceable Filter

(71) Applicant: Nile Hudson LLC, New York, NY (US)

(72) Inventor: Neel Elsherif, New York, NY (US)

(73) Assignee: Nile Hudson LLC

(21) Appl. No.: 17/226,549

(22) Filed: Apr. 9, 2021

Related U.S. Application Data
(60) Provisional application No. 63/007,437, filed on Apr. 9, 2020.

(51) Int. Cl. A62B 23/02; A41D 13/11

(52) U.S. Cl. CPC A62B 23/025; A41D 13/1161; A41D 13/1107

(57) ABSTRACT

A protective face mask is provided that includes a mask body having a pair of opposing ends that taper inwardly from a middle portion including an upper nose cover and a lower mouth cover. An ear loop including a slide adjuster is affixed to each of the opposing ends of the mask body. A pocket having at least one vertical opening slot is disposed within an interior side of the mask body to receive a replaceable filter therein.

### CROSS-REFERENCE TO RELATED APPLICATIONS

The present application claims the benefit of priority to U.S. provisional patent application Ser. No. 63/007,437, titled “Face Mask With Replaceable Filter,” filed Apr. 9, 2020, which is incorporated by reference herein in its entirety.

### BACKGROUND

This specification relates generally to protective face masks. More particularly, the specification relates to a protective face mask having adjustable securement mechanisms and filters that can be removed and replaced as needed.

In environments such as hospitals and other medical facilities, it is important for medical professionals to use personal protective equipment. Such equipment often includes a face mask that covers the nose and mouth of the wearer. A face mask is intended to protect the wearer and surrounding individuals by preventing the spread of bacteria, viral particles, and other contaminates. During pandemics and similar emergencies, the need for personal protective equipment such as face masks extends beyond medical professionals to the general public. Typical surgical masks provide some protection against large droplets and protect others from the wearer's exhalations, while respirators having N95-rated filters reduce exposure to smaller aerosol particles as well as larger droplets. In situations where individuals are advised to wear protective face masks for extended periods of time, it can be difficult to secure enough disposable face masks for this purpose. Additionally, most face masks are often uncomfortable to wear for extended periods. In view of the above concerns, it is desirable to provide a protective face mask having and adjustable securement mechanism for comfort and a replaceable filter.

Devices have been disclosed in the known art that relate to protective face masks. These include devices that have been patented and disclosed in patent application publications. However, the devices in the known art have several drawbacks. For example, many face masks are considered single use or must be sterilized between uses. The disposable nature of these face masks limits the utility of the face mask and increases waste. Further, sterilization processes are time consuming and may not be entirely effective. Another drawback is that existing face masks are often difficult to adjust to achieve a proper fit against the wearer's face, as these face masks typically include static ear loops or other non-adjustable fasteners that become irritating and uncomfortable when the face mask is worn for long periods of time.

In light of the devices disclosed in the known art, it is submitted that the present invention substantially diverges in functional and design elements from the known art and consequently it is clear that there is a need in the art for an improvement to existing protective face masks. In this regard the present invention substantially fulfills these needs.

### SUMMARY

In view of the foregoing disadvantages inherent in the types of protective face masks now present in the known art, the present invention provides a protective face mask wherein the same can be utilized for reducing the droplet and aerosol transmissions from the user's exhalations, and for protecting the wearer from inhaling germs and other unwanted substances.

The protective face mask generally includes a mask body having a pair of opposing ends that taper inwardly from a middle portion of the mask body. The middle portion includes an upper nose cover and a lower mouth cover, defining the overall shape of the mask body. An ear loop or other adjustable fastener, such as an adjustable head strap, for example, is affixed to each of the opposing ends of the mask body. The ear loops include slide adjusters for adjusting the overall fit of the mask body as it is secured to the wearer's ears. A rigid shaping element is disposed within the upper nose cover section for conforming the upper nose cover portion of the mask body to the nose of the wearer. An interior shaping wire is disposed within an upper perimeter edge of the mask body for further shaping and conforming the mask body to the wearer's face. A pocket having a closed end and a vertical opening slot is disposed within the interior side of the mask body. The pocket is configured to receive an filter that conforms to the overall shape of the mask body, which can be replaced with new filters as needed.

Other objects, features, and advantages of the present invention will become apparent from the following detailed description taken in conjunction with the accompanying figures.

### BRIEF DESCRIPTION OF THE DRAWINGS

FIG. 1 shows an outside front elevation view of an embodiment of the protective face mask.

FIG. 2 shows an exemplary ear loop slide adjuster according to an embodiment.

FIG. 3 shows an inside rear elevation view of an embodiment of the protective face mask.

FIG. 4 shows a front elevation view of an exemplary replaceable filter according to an embodiment.

FIG. 5 shows an alternative protective face mask according to an embodiment.

### DETAILED DESCRIPTION

Reference is made herein to the attached figures. For the purposes of presenting a brief and clear description of the present invention, the preferred embodiment will be discussed as used protecting the wearer and surrounding individuals from droplets and aerosols that may include bacteria, viral particles, or other undesirable substances. The figures are intended for representative purposes only and should not be considered to be limiting in any respect. Figures that include dimensions are for example purposes and are not meant to limit the present invention to any particular dimensions.

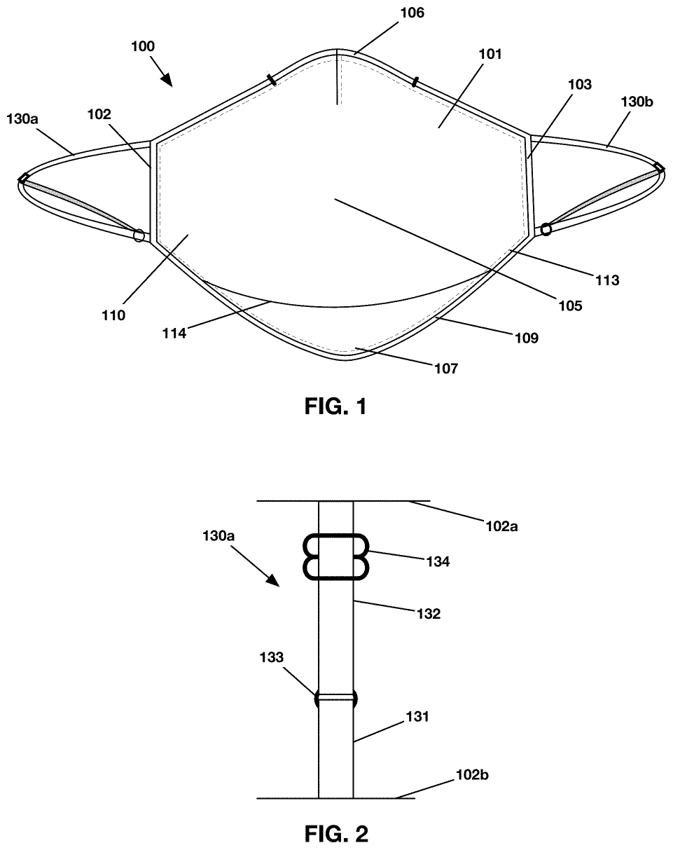

Referring to FIG. 1, an outside front elevation view of an embodiment of the protective face mask 100 is illustrated. As shown, the face mask 100 includes a mask body 101 having a pair of opposing ends 102, 103 that taper inwardly from a middle portion 105 of the mask body. The middle portion 105 includes an upper nose cover 106 and a lower mouth cover 107, defining the overall shape of the mask body 101. The mask body 101 may comprise a total width of about 9.5 inches and a total height of either about 6.75 inches or about 7 inches for two different sizes of face mask.

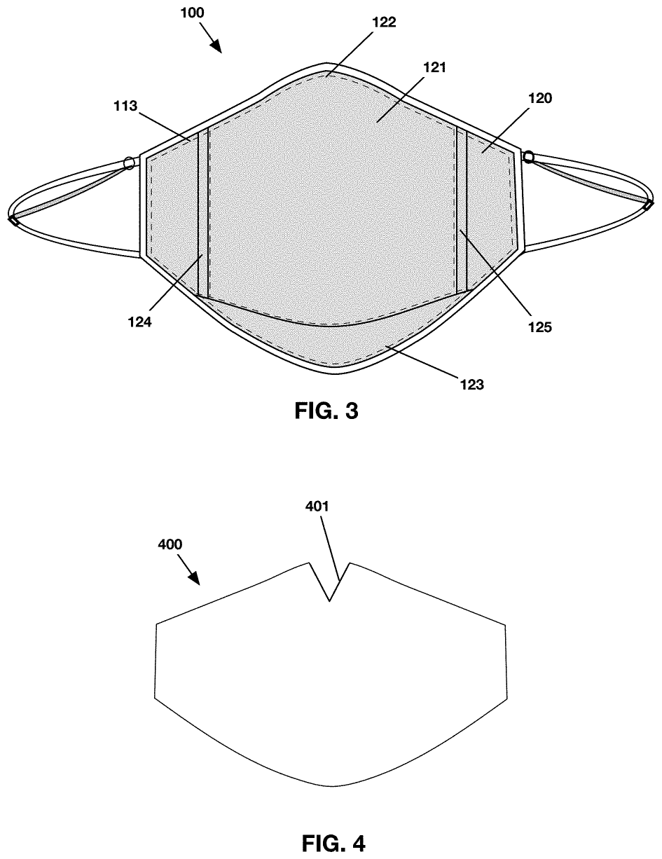

The mask body 101 may comprise an outer layer 110 connected to an inner layer (see FIG. 3 at 120) via stitching or the like 113. A seam 114 extends across the mask body 101 at an upper end of the lower mouth covering portion 107 and may include similar top stitching.

Both layers 110, 120 may comprise an anti-bacterial, wicking, single jersey fabric material. For example, the material of each layer may comprise about 92 percent recycled polyester and about 8 percent spandex single jersey having a density of about 165 GSM. The material is generally configured to be resistant to Staphylococcus aureus, Escherichia coli, and Klebsiella pneumoniae.

In one embodiment, one or more fragrances may be applied to the inner 120 and/or outer layer 100 via the use of microcapsules. For example, microcapsules containing a fragrance may be applied to the inner and/or outer layer via padding, coating, spraying or immersion. Such microcapsules may comprise a diameter of from about 3 micrometers to about 8 micrometers to provide a maximum concentration of about 1 million microcapsules per square centimeter. Exemplary fragrances may include fruit, floral and herbs and spices scents (e.g., mint).

In one embodiment, a shaping member may be disposed within the upper nose covering portion 106. The shaping member includes a vertical orientation with an upper end that extends to the uppermost point of the nose cover 106. The mask body 101 further includes a shapeable interior wire disposed along an interior perimeter 109 of the mask body, which further helps the mask body to conform to the face and nose of the wearer.

As shown in FIGS. 1 and 2, an ear loop 130a, 130b is affixed to each of the opposing ends 102, 103 of the mask body 101, which define vertically oriented side perimeter edges. Generally, each ear loop 130a includes a first end affixed to an upper end of the side perimeter edge 102a and a second end affixed to a lower end of the side perimeter edge 102b, defining a loop configuration.

Each ear loop 130a may comprise a fixed strap 131 and an adjustment strap 132. The fixed strap 131 includes a first end attached to the lower end of the side perimeter edge 102b and a second end connected to a ring 133. The adjustment strap 132 includes a first end affixed to the upper end of the side perimeter edge 102a and a second end connected to a double-loop slide adjuster 134. The adjustment strap 131 is threaded through both the ring 133 and the slide adjuster 134 such that the user may adjust a length of the loop 103a for improved fit and comfort during wear. In an alternate embodiment of the invention, an adjustable head strap is utilized in place of adjustable ear loops.

Referring to FIG. 3, an inside rear elevation view of the protective face mask 100 is illustrated. As shown, an inner layer 120 of the protective face mask 100 is connected to the outer layer (FIG. 1 at 110) to form a pocket 121 having closed top 122 and bottom 123 edges. At least one of the sides of the pocket 121 comprises a vertical opening slot 124, 125 configured to receive a replaceable filter therein.

In one embodiment, the pocket 121 comprises a width of about 4 inches with vertical edges 124, 125 positioned about 2 inches from the side edges of the mask body 101. The opening slot(s) 124, 125 of the pocket 121 may each comprise a self-folding fabric that defines a clean finish and comfortable fit when a filter is secured within the pocket and the mask is worn.

Referring to FIG. 4, an exemplary replaceable filter 400 according to an embodiment is illustrated. As shown, the filter 400 comprises a size and shape complementary to the size and shape of the pocket (see FIG. 3 at 121) such that the filter may be removably inserted into the pocket via one of the vertical opening slots (see FIG. 3 at 124, 125). In one specific embodiment, the filter 400 comprises a height of about 4.625 inches and a width of about 6.25 inches.

In one embodiment, the filter 400 may comprise a triangular cutout 401 at a top portion thereof. It will be appreciated that, when the filter 400 is disposed within the pocket of the face mask, the cutout 401 aligns with the upper nose cover (see FIG. 1 at 106). Accordingly, the cutout 401 allows the filter 400 to flex or bend about a user's nose when the face mask is worn.

The filter 400 may be configured to achieve N95 filtration standards. Particularly, the filter may be configured to maintain a bacterial and viral filtration efficiency of greater than 95 percent (e.g., at least about 95 percent, at least about 96 percent, at least about 97 percent, at least about 98, or at least about 99 percent). In the illustrated embodiment, the filter comprises a polyester and polyvinylidene fluoride (“PVDF”) nanofiber material having a density of about 40 GSM. In other embodiments, other types of filters may be utilized.

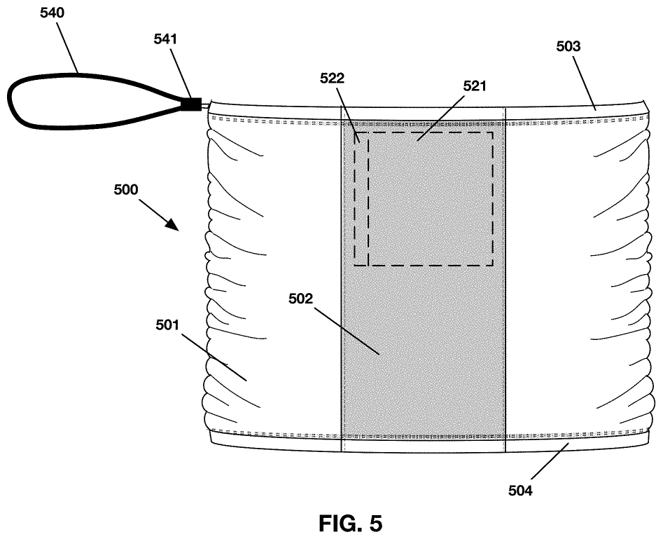

Referring to FIG. 5, an alternative embodiment of a protective face mask 500 is shown. The illustrated mask 500 is configured to be worn around a user's neck; as such, the mask 500 may be sized and shaped such that a portion of the mask may be pulled upward from the user's neck to cover the user's mouth and nose.

As shown, the mask 500 may comprise a rectangular front portion 502 connected to a rear portion 501 via stitching or the like. In one embodiment, the rear 501 and front 502 portions may each comprise an anti-bacterial, wicking, single jersey fabric material. For example, the material of each layer may comprise about 92 percent recycled polyester and about 8 percent spandex single jersey having a density of about 165 GSM.

In other embodiments, the rear 501 and front 502 portions may comprise different materials. For example, the front portion 502 may comprise a mesh filter insert panel for added breathability. In one embodiment, one or more microencapsulated fragrances may be applied to the rear and/or front portion.

In one embodiment, a pocket 521 is disposed on an inner surface of the front portion 502. As discussed above, the pocket 521 may be configured to removably hold a filter (not shown) therewithin. To that end, the pocket 521 may comprise at least one vertical opening slot 522 sized to receive a removable filter. The opening slot 522 of the pocket 521 may comprise a self-folding fabric that defines a clean finish and comfortable fit when a filter is secured within the pocket and the mask is worn.

As shown, the rear 501 and front 502 portions extend vertically from a top edge 503 of the mask 500 to an elastic bottom edge 504 thereof. In one embodiment, an elastic cord 540 is partially disposed within an interior of the top edge 503. An adjustable slider 541 may be affixed to the elastic cord 540 to allow for tightening/loosening of the top edge 503 as desired.

As packaged, the protective face masks disclosed herein are ideally vacuum sealed within a poly bag, along with one or more filters vacuum sealed within another poly bag. The packaging may include reusable EVA/PVS clear bags with sliding closures, allowing the masks to be easily stored when not in use. The filters can also be sold separately as refills.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

All references, including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A protective face mask comprising:
a mask body comprising:
a middle portion comprising an upper nose cover and a lower mouth cover; and
a pair of opposing ends that taper inwardly from the middle portion; and
a pair of ear loops, each affixed to one of the pair of opposing ends and each comprising a slide adjuster for adjusting a fit of the respective ear loop around an ear of a user.

2. The protective face mask of claim 1, wherein the mask body comprises an outer layer connected to an inner layer via stitching.

3. The protective face mask of claim 2, wherein at least one of the outer layer and the inner layer comprises an anti-bacterial, wicking, single jersey fabric material.

4. The protective face mask of claim 3, wherein the material comprises about 92 percent recycled polyester and about 8 percent spandex single jersey fabric.

5. The protective face mask of claim 4, wherein the material comprises a density of about 165 GSM.

6. The protective face mask of claim 2, wherein the inner layer is connected to the outer layer to form a pocket comprising:
closed top and bottom sides; and
open left and right sides forming vertical opening slots configured to receive a replaceable filter therein.

7. The protective face mask of claim 6, further comprising a replaceable filter seated within the pocket.

8. The protective face mask of claim 7, wherein the filter is configured to achieve N95 filtration standards.

9. The protective face mask of claim 8, wherein the filter comprises a polyester and polyvinylidene fluoride (“PVDF”) nanofiber material having a density of about 40 GSM.

10. The protective face mask of claim 7, wherein the filter comprises a height of about 4.625 inches and a width of about 6.25 inches.

11. The protective face mask of claim 7, wherein the filter comprises a triangular cutout at a top portion thereof to allow the filter to flex or bend about a nose of a user when the face mask is worn.

12. The protective face mask of claim 2, wherein at least one of the inner layer and the outer layer comprises microcapsules containing a fragrance applied thereto.

13. The protective face mask of claim 1, further comprising a rigid shaping element disposed within the upper nose cover.

14. The protective face mask of claim 1, further comprising an interior shaping wire disposed within an upper perimeter edge of the mask body.

15. The protective face mask of claim 1, wherein the mask body comprises a total width of about 9.5 inches.

16. The protective face mask of claim 15, wherein the mask body comprises a total height of about 6.75 inches or about 7 inches.
